(19) United States
(12) Patent Application Publication
(10) Pub. No.: US 2009/0154860 A1
(43) Pub. Date: Jun. 18, 2009

(54) TAPERED ROLLER BEARING

(75) Inventors: Heinrich Hofmann, Schweinfurt (DE); Johannes De Boer, Uechtelhausen (DE); Horst Doeppling, Herzogenaurach (DE); Bernhard Wilm, Nuedlingen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/719,590

(22) PCT Filed: Nov. 11, 2005
(86) PCT No.: PCT/DE2005/002035

§ 371 Date: Jul. 12, 2007

(30) Foreign Application Priority Data
Nov. 17, 2004 (DE) 10 2004 055 227.4

(51) Int. Cl. F16C 19/36

(52) U.S. Cl. 384/565

(57) ABSTRACT

The invention relates to a tapered roller bearing comprising at least one conical outer roller track, at least one conical inner roller track and tapered rollers which are arranged in a radial manner between the roller tracks and about the longitudinal central axis of the tapered roller bearing. The tapered rollers respectively comprise a conical first covering surface for carrying out an effective radial connection towards the outside in the rolling contact with the inner roller track and for carrying out an effective radial connection towards the inside in the rolling contact with the outer roller track and the central lines of the tapered rollers intersect in a common intersecting point on the longitudinal central axis.

### FIELD OF THE INVENTION

The invention relates to a tapered roller bearing having at least one conical outer raceway, at least one conical inner raceway and having rollers which are arranged radially between the raceways and in the process about the longitudinal center axis of the tapered roller bearing, the rollers having in each case one conical circumferential face for an operative connection radially to the outside in rolling contact with the inner raceway and for an operative connection radially to the inside in rolling contact with the outer raceway.

### BACKGROUND OF THE INVENTION

Tapered roller bearings of this type are described in U.S. Pat. No. 4,065,191. Conventional tapered roller bearings are those tapered roller bearings, in which the center lines of the rollers, the generatrices for the inner raceways on the outer ring side and the generatrices of the outer raceway on the inner ring side intersect at a common point on the longitudinal center axis of the tapered roller bearing. The generatrices are arranged on the circumferential side adjacent to one another in any desired number and describe the inclination and therefore the cone angle of the respective raceway in sectional planes longitudinally along the longitudinal center axis of the bearing. The geometry of conventional tapered roller bearings is considered in the expert world, in the first instance, as the geometry in which virtually only rolling contact occurs in the operative connection between the rollers and the raceways on account of uniform circumferential speeds.

As a result of the inclination angle of the raceways and the cone angle of the rollers, axial components are produced on the rollers from radial forces during operation of the bearing. The axial components displace the rollers axially against the rims, with the result that frictional contact is produced between the rims and the end sides of the rollers. The greater the inclination angles, accordingly, the higher the losses as a result of sliding friction between the rollers and the rim. Moreover, the rollers are braked on one side in their rolling movement as a result of the sliding contact on the rim, with the result that the rollers are crossed against the ideal rolling direction. This also produces undesirable sliding friction in the operative connections between the circumferential face of the tapered rollers and the circumferential faces of the raceways.

U.S. Pat. No. 4,065,191 describes solution approaches, by which this known problem is to be eliminated or the effect is to be reduced considerably. Circumferential faces are provided which are not described by a rectilinear generatrix, but by generatrices which are bent away in a pronounced manner in the direction of the longitudinal center axis in a manner which deviates from the level of customary profiling of the rolling contact. Accordingly, the profile of generatrices of this type, in a manner which deviates from the conventional design, is not described by an angle between the generatrices and the longitudinal center axis but by at least two angles which are different from one another. In each case two vertices are therefore produced. The rollers which are, in the first instance, of all crossed as a result of the rim contact are briefly oriented in the rolling direction on raceways which are bent away in this way, and then tilt away and again run onto the rim. The rolling contact between the rolling body and the raceway is no longer ensured over the entire effectively loadbearing length of the rolling bodies. Moreover, the raceways can be manufactured on the bearing rings only with great expenditure.

### SUMMARY OF THE INVENTION

It is therefore the object of the invention to provide a tapered roller bearing which can be manufactured simply and, as a result of the raceway and roller geometries of which, low axial forces are produced on the rolling bodies.

This object is achieved according to the subject matter of claim 1 for a tapered roller bearing and, by way of a further claim, by a roller for a tapered roller bearing of this type.

The tapered roller bearing has at least one conical outer raceway. The outer raceway is formed on an inner ring. The invention is also provided for tapered roller bearings which have two of the outer raceways on one inner ring or which have more than one of the inner rings, of which at least one has at least one of the outer raceways.

The tapered roller bearing has at least one conical inner raceway. The inner raceway is formed on an outer ring. The invention is also provided for tapered roller bearings which have two of the inner raceways on one outer ring or which have more than one of the outer rings, of which at least one has at least one of the inner raceways.

The tapered roller bearing has at least one row of tapered rollers. The tapered rollers are arranged radially between the raceways and in the process about the longitudinal center axis of the tapered roller bearing. The conical circumferential face lies radially to the outside and to the inside in an operative connection with the inner and the outer raceway, respectively. The operative connection consists predominantly of rolling contact, but can also have portions of sliding friction contact.

The application of the invention is provided, in particular, in wheel bearings. It is therefore also conceivable that at least one of the inner raceways of the wheel bearing is configured, for example, in one piece together with a body, on which fastening elements such as flanges or the like are also provided for fastening the wheel bearing on the vehicle side or for fastening elements of a brake or for fastening a vehicle wheel. It is also conceivable that at least one of the outer raceways is formed directly on a hub of the wheel bearing, by way of which the wheel bearing, for example, is fixed to the vehicle or to which a wheel which can rotate with the wheel bearing is fastened. A tapered roller bearing having at least two rows and the outer ring or rings mounted in the body and the inner ring on the hub is also conceivable.

The circumferential faces of the raceways are delimited by generatrices, the imaginary extensions of which intersect in each case at one vertex per raceway. The respective vertex of the generatrices or the vertex of their extensions for the inner raceway and also for the outer raceway lies on the longitudinal center axis of the tapered roller bearing. The point of intersection, at which those generatrices of the tapered rollers of one row which are inclined with respect to one another intersect, lies between these two vertices. The extensions of the generatrices which describe the orientation of the generatrices of the conical casing of the rollers intersect at a point of intersection which does not lie on the longitudinal center axis of the tapered roller bearing, but rather lies radially spaced apart from the longitudinal center axis.

The extensions of the generatrices of the tapered roller intersect at the common vertex on the center axis of the tapered roller. According to the invention, the magnitude of the cone angle which is always enclosed between two extensions of the generatrices of the tapered roller in a common longitudinal plane is not smaller than 1° and is not greater than 4°. The preferred cone angle is 1°30′<α<2°. The longitudinal plane is an imaginary sectional plane through the roller which is sectioned along the center axis. The tapered roller is a flat tapered roller having a flat cone angle in comparison with conventional tapered rollers. The axial components of the bearing loading which were described in the introduction are correspondingly low.

The generatrices of the inner raceway on the outer ring or a housing (or the like) are inclined in each case at a first inclination angle with respect to the longitudinal center axis which is not smaller than 8° and not greater than 25°.

The generatrices of the outer raceway on the inner ring or on a shaft (or the like) and the longitudinal center axis enclose in each case a second inclination angle between them which is not smaller than 7° and not greater than 22°. The preferred second inclination angle is 15°≦α≦16°.

One refinement of the invention provides a tapered roller bearing, the outer ring of which has an annular rim for the axial running on of the rolling bodies and a rimless inner ring of the tapered roller bearing. The inner ring can be manufactured simply. The bearing can be manufactured inexpensively overall, in particular when at least one of the rings is a cold formed part.

### DESCRIPTION OF THE DRAWINGS

FIG. 1 shows an illustration of a tapered roller bearing 1 according to the invention in a sectional plane of a longitudinal section along the longitudinal center axis 1a. The tapered roller bearing 1 is used, for example, in a wheel bearing, paired with at least one further tapered roller bearing. The tapered roller bearing 1 has an inner ring 2, an outer ring 3 and tapered rollers 4. The outer ring 3 is provided with an annular rim 5. The annular rim 5 protrudes radially beyond the inner raceway 6 in the direction of the longitudinal center axis 1a, with the result that the tapered rollers 4 run axially against the former by way of their end sides 4a. The rimless inner ring 2 has the outer raceway 7.

The extensions of the generatrices 8a of the circumferential face 8 of the outer raceway intersect on the longitudinal center axis 1a at the vertex 9. The extensions of the generatrices 10a of the circumferential face 10 of the inner raceway 6 intersect at a vertex 11 which is axially spaced apart from the vertex 9. The center lines 12 of each tapered roller 4 intersect at the point of intersection 13 on the longitudinal center axis 1a. Of the three points 9, 11 and 13, the vertex 9 is axially closest to the tapered roller bearing 1. The point of intersection 13 lies axially between the vertex 9 and the vertex 11. The generatrices 8a are inclined at an angle α1=second inclination angle with respect to the longitudinal center axis 1a, and the generatrices 10a are inclined at an angle of α2=first inclination angle. The center lines 12 and the longitudinal center axis 1a enclose an angle of α3 between them.

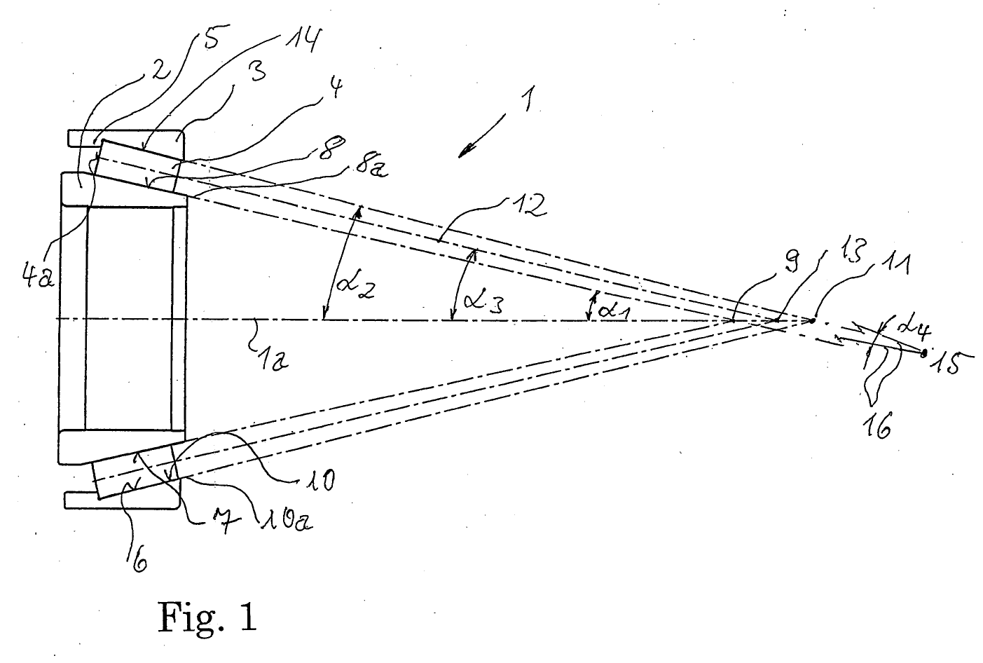

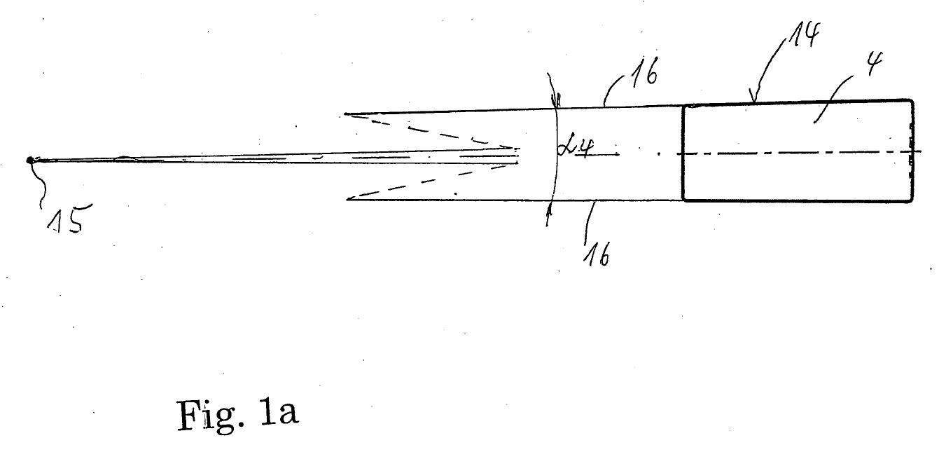

The extensions of the generatrices of the tapered rollers 4 are symbolized by the lines 16 (cf., in particular, FIG. 1a) and intersect at a vertex 15 which, on account of the low cone angle α4, lies outside the image area of FIG. 1 and generally spaced apart from the longitudinal center axis. FIG. 1a shows a tapered roller according to the invention, for example a tapered roller 4, in which the cone angle α4=1°30′ is not shown to scale and with interrupted and therefore shortened lines.

### LIST OF DESIGNATIONS

1 Tapered roller bearing

1a Longitudinal center axis

2 Inner ring

3 Outer ring

4 Tapered rollers

4a End side

5 Annular rim

6 Inner raceway

7 Outer raceway

8 Circumferential face

8a Generatrix

9 Vertex

10 Circumferential face

10a Generatrix

11 Vertex

12 Center line

13 Point of intersection

14 Cone envelope

15 Vertex

16 Line

1. A tapered roller bearing comprising: at least one conical outer raceway, at least one conical inner raceway and having tapered rollers which are arranged radially between the raceways and about the longitudinal center axis of the tapered roller bearing, the tapered rollers having a conical first circumferential face for an operative connection radially to the outside in rolling contact with the inner raceway and for an operative connection radially to the inside in rolling contact with the outer raceway, and the center lines of the tapered rollers intersecting at a common point of intersection on the longitudinal center axis, and imaginary extensions
of first generatrices of the first circumferential face of the tapered roller intersecting at a common first vertex which is remote from the longitudinal center axis,
of second generatrices of a second circumferential face of the inner raceway intersecting at a common second vertex on the longitudinal center axis,
of third generatrices of a third circumferential face of the outer raceway intersecting at a common third vertex on the longitudinal center axis,
and the second vertex and the third vertex being spaced apart from one another on the longitudinal center axis and enclosing the point of intersection axially between them.

2. The tapered roller bearing as claimed in claim 1, in which the first generatrices enclose a first cone angle between them which is greater than or equal to 1° and less than or equal to 4°, the cone angle being formed between the first generatrices which lie opposite one another in a common sectional plane through the tapered roller bearing which extends along the longitudinal center axis.

3. The tapered roller bearing as claimed in claim 1, in which the second generatrices are inclined at a first inclination angle with respect to the longitudinal center axis, which first inclination angle is greater than or equal to 8° and less than or equal to 25°.

4. The tapered roller bearing as claimed in claim 1, in which the third generatrices and the longitudinal center axis enclose a second inclination angle between them which is greater than or equal to 15° and less than or equal to 16°.

5. The tapered roller bearing as claimed in claim 1, in which at least one of the inner raceways is configured with an annular rim which protrudes radially beyond the inner raceway in the direction of the longitudinal center axis for the axial running on of the tapered rollers, on the inside on an outer ring of the tapered roller bearing, which outer ring surrounds the tapered rollers on the outside.

6. The tapered roller bearing as claimed in claim 1, in which at least one of the outer raceways is formed on the outside on a rimless inner ring of the tapered roller bearing.

7. The tapered roller bearing as claimed in claim 8, in which at least one of the rings is a cold formed part.

8. A tapered roller for the tapered roller bearing as claimed in claim 1, in which first generatrices enclose a first cone angle between them which is greater than 1° and less than 4°, the first generatrices extending in a common sectional plane through the tapered roller which extends along the center line of the roller.

9. The tapered roller as claimed in claim 8, in which the first cone angle is greater than 1° and less than 3°.
